(19) United States
(12) Patent Application Publication
(10) Pub. No.: US 2019/0079657 A1
(43) Pub. Date: Mar. 14, 2019

(54) Control Device For Dynamically Providing Control Interface On Basis Of Change In Position Of User, Method For Dynamically Providing Control Interface In Control Device, And Computer Readable Recording Medium With Computer Program For Executing Method Recorded Thereon

(71) Applicant: FUTUREPLAY INC., Seoul (KR)

(72) Inventors: Sungjae HWANG, Seongnam-si, Gyeonggi-do (KR); Jaeyeon KIHM, Uiwang-si, Gyeonggi-do (KR)

(73) Assignee: FUTUREPLAY INC., Seoul (KR)

(21) Appl. No.: 16/083,585

(22) PCT Filed: Mar. 8, 2017
(86) PCT No.: PCT/KR2017/002533

§ 371 Date: Sep. 10, 2018

(30) Foreign Application Priority Data
Mar. 8, 2016 (KR) 10-2016-0027873

(51) Int. Cl. G06F 3/0481; G06F 1/16; G06F 3/0488

(52) U.S. Cl. CPC G06F 3/04817; G06F 2200/1637; G06F 3/0488; G06F 1/1694

(57) ABSTRACT

According to one aspect of the invention, there is provided a method for dynamically providing a control interface in a control device of a user, comprising the steps of: deriving information on a posture change of the user, on the basis of a motion data of the control device, wherein the motion data is recorded over time by means of a sensor included in the control device; and dynamically organizing and providing the control interface in the control device, on the basis of the derived information.

### FIELD OF THE INVENTION

The present invention relates to a control device for dynamically providing a control interface on the basis of a posture change of a user, a method for dynamically providing a control interface in the control device, and a computer-readable recording medium having stored thereon a computer program for executing the method.

### BACKGROUND

Recently, wearable devices that may be worn on or attached close to a body of a user have been widely used. Such wearable devices are often used to control nearby electronic devices or Internet of Things (IoT) appliances.

One of the differences between wearable devices and existing first-generation smart devices is that the wearable devices may have physical values closely related to motions or postures of the user. Thus, different control commands may be defined according to the physical values that the wearable devices may have.

Taking a step forward from the above, the present inventor(s) suggest a technique for drastically improving a control interface of a wearable device that may be used to control electronic devices or IoT appliances.

### SUMMARY OF THE INVENTION

One object of the present invention is to solve all the above-described problems in the prior art.

Another object of the invention is to dynamically provide a control interface in a control device on the basis of a posture change of a user.

Yet another object of the invention is to give further consideration to characteristics or positions of electronic devices or IoT appliances to be controlled, when the control interface is provided as above.

The representative configurations of the invention to achieve the above objects are described below.

According to one aspect of the invention, there is provided a method for dynamically providing a control interface in a control device of a user, comprising the steps of: deriving information on a posture change of the user, on the basis of a motion data of the control device, wherein the motion data is recorded over time by means of a sensor included in the control device; and dynamically organizing and providing the control interface in the control device, on the basis of the derived information.

In addition, there are further provided other methods and other control devices to implement the invention, as well as computer-readable recording media having stored thereon computer programs for executing the methods.

According to the invention, it is possible to dynamically provide a control interface in a control device on the basis of a posture change of a user.

According to the invention, it is possible to give further consideration to characteristics or positions of electronic devices or IoT appliances to be controlled, when the control interface is provided as above.

### BRIEF DESCRIPTION OF THE DRAWINGS

FIG. 1 schematically shows the configuration of an entire system for dynamically providing a control interface in a control device on the basis of a posture change of a user according to one embodiment of the invention.

FIG. 2 specifically shows the internal configuration of a control assistance system 200 according to one embodiment of the invention.

FIG. 3 specifically shows the internal configuration of a control device 300 according to one embodiment of the invention.

FIG. 4 shows a posture that a user may take for the control by a control device and a control interface at the time according to one embodiment of the invention.

FIG. 5 shows an example of a control interface when a user wears a control device on his/her wrist indoors according to one embodiment of the invention.

FIG. 6 shows an example of a control interface when a user uses a control device in a standing posture according to one embodiment of the invention.

FIG. 7 shows an example of a control interface when a user uses a control device in a room according to one embodiment of the invention.

FIG. 8 shows an example of a control interface when a user uses a control device in an autonomous vehicle according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Configuration of the Entire System

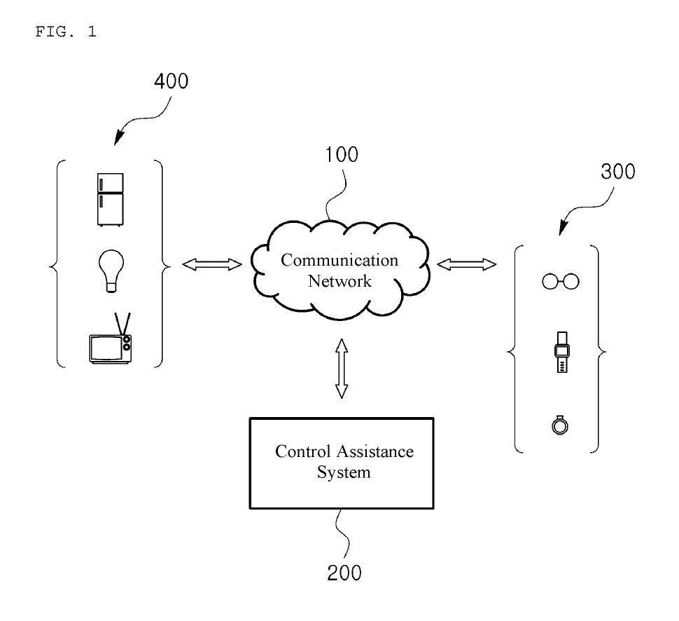

FIG. 1 schematically shows the configuration of an entire system for dynamically providing a control interface in a control device on the basis of a posture change of a user according to one embodiment of the invention.

As shown in FIG. 1, the entire system according to one embodiment of the invention may comprise a communication network 100, a control assistance system 200, a control device 300, and an external device 400 (i.e., an electronic device or IoT appliance to be controlled).

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks. For example, the communication network 100 may be a wireless data communication network, at least a part of which may be implemented with a conventional communication scheme such as WiFi communication, Long Term Evolution (LTE) communication, Bluetooth communication, infrared communication, and ultrasonic communication. Further, at least a part of the communication network 100 may be implemented with a communication scheme of the fifth generation wireless communication announced at the prominent CES (Consumer Electronics Show) in January 2017.

Next, the control assistance system 200 according to one embodiment of the invention may assist in dynamically providing a control interface to a user in the control device 300, when the user changes his/her posture with the control device 300 being worn on or attached close to his/her body. To this end, the control assistance system 200 may assist the control device 300 to communicate with each external device 400 to be controlled via the communication network 100. In many cases, there may be a plurality of external devices 400 to be controlled.

The configuration and function of the control assistance system 200 according to the invention will be discussed in more detail below.

Meanwhile, the above control assistance system 200 may not be necessarily required when a control signal may be directly transmitted from the control device 300 to the external device 400 without going through the control assistance system 200. For example, the control assistance system 200 may not be necessarily required when the control device 300 may transmit a pre-arranged infrared signal to the external device 400, and then the external device 400 may decipher the signal and perform an operation or action accordingly. Further, the control device 300 and the external device 400 may directly communicate with each other by any other of the various wireless communication schemes as described above.

Next, the control device 300 according to one embodiment of the invention may be digital equipment that may communicate with the control assistance system system 200 or the external device 400 as necessary, and any type of digital equipment that may be worn on or attached close to a body of a user and has a memory means and a microprocessor for computing capabilities (such as a smart watch, a smart band, a smart ring, a smart glass, a smart phone, a mobile phone, and a personal digital assistant (PDA)) may be adopted as the control device 300 according to the invention. Particularly, the control device 300 may include an element for control of the external device 400, e.g., a control interface that allows the user to make an input for the control as will be described in detail below. The control device 300 may autonomously derive information on a posture change of the user, or may receive such information from the control assistance system 200 and then dynamically provide a control interface on the basis of the information.

The configuration and function of the control device 300 according to the invention will be discussed in more detail below.

Lastly, the external device 400 according to one embodiment of the invention may be any electronic device or IoT appliance that may be controlled. The external device 400 may receive a control signal from the control assistance system 200 or the control device 300 via the communication network 100 and may be controlled accordingly. Various examples of the external device 400 will be further discussed below.

Configuration of the control assistance system Hereinafter, the internal configuration of the control assistance system 200 according to the invention and the functions of the respective components thereof will be discussed.

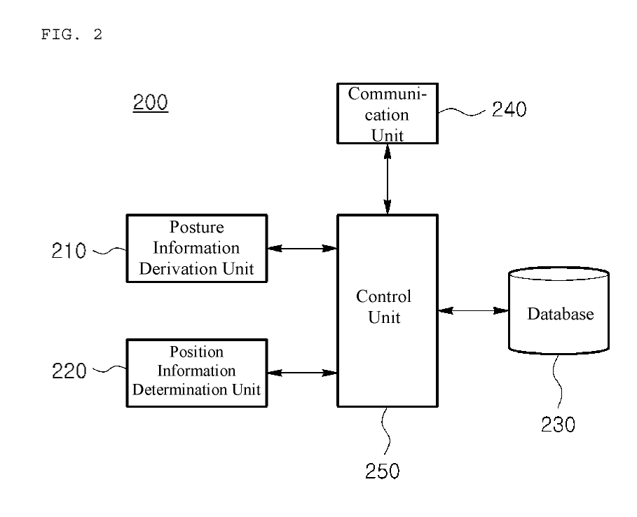

FIG. 2 specifically shows the internal configuration of the control assistance system 200 according to one embodiment of the invention.

The control assistance system 200 according to one embodiment of the invention may be digital equipment having a memory means and a microprocessor for computing capabilities. The control assistance system 200 may be a server system. As shown in FIG. 2, the control assistance system 200 may comprise a posture information derivation unit 210, a position information determination unit 220, a database 230, a communication unit 240, and a control unit 250. According to one embodiment of the invention, at least some of the posture information derivation unit 210, the position information determination unit 220, the database 230, the communication unit 240, and the control unit 250 may be program modules to communicate with the control device 300 or the external device 400. The program modules may be included in the control assistance system 200 in the form of operating systems, application program modules, and other program modules, while they may be physically stored in a variety of commonly known storage devices. Further, the program modules may also be stored in a remote storage device that may communicate with the control assistance system 200. Meanwhile, such program modules may include, but not limited to, routines, subroutines, programs, objects, components, data structures, and the like for performing specific tasks or executing specific abstract data types as will be described below in accordance with the invention.

First, the posture information derivation unit 210 according to one embodiment of the invention may function to receive data on a motion of the control device 300 (to be described below) from the control device 300, and to derive information on a posture change of a user using the control device 300 on the basis of the data. Specifically, on the basis of the motion data of the control device 300, the posture information derivation unit 210 may derive the information on the posture change of the user by determining information on a trajectory that the control device 300 shows in a situation where the control device 300 is worn on or disposed close to the user's body, wherein the information on the trajectory may include information on absolute positions over time of the control device 300, information on relative positions over time of the control device 300 with respect to a predetermined virtual reference point or a device other than the control device 300, or information on velocity, acceleration, three-axis rotation, and the like (over time) of the control device 300.

To this end, the posture information derivation unit 210 may perform collection and accumulation of the information with respect to a plurality of control devices 300 respectively used by a plurality of users, thereby matching a motion trajectory having characteristics within predetermined ranges to a known posture change, or specifying a new posture change on the basis of a motion trajectory having characteristics within predetermined ranges. Further, when there is a motion trajectory common to the plurality of control devices 300, the posture information derivation unit 210 may analyze the characteristics of the motion trajectory and determine the corresponding motion as a specific type of motion (i.e., a specific posture change). Furthermore, when a motion having trajectory characteristics corresponding to those of the determined type of motion is detected with respect to a separate control device 300, a specific posture change may be inferred from the motion of that control device 300. It is also possible to infer a region of the user's body where the control device 300 is worn. For example, it is possible to infer a region (or position) where the control device 300 is worn among the user's finger, wrist, and upper arm.

Meanwhile, the derived posture information (which includes information on the position where the control device 300 is worn on the user's body, as necessary) may be stored in the database 230 (to be described below) in association with the characteristics of the corresponding motion trajectory.

Here, the posture information derivation unit 210 as described above is not essential, and all or some of its functions may be performed instead by a posture information derivation unit 320 that may be included in the control device 300 as will be described below.

Next, the position information determination unit 220 according to one embodiment of the invention may determine a positional relationship between the control device 300 and the external device 400, on the basis of a position or orientation of the control device 300 and/or a position or orientation of the external device 400, and may provide information on the determined positional relationship to the control device 300. The positional relationship may be a spatial or planar angle between the orientations of the control device 300 and the external device 400, a distance between the two devices, or a combination of the angle and distance. Here, the position information determination unit 220 is not essential, and all or some of its functions may be performed instead by a position information determination unit 330 that may be included in the control device 300 as will be described below.

In determining the positional relationship, pre-registered information on a position and/or orientation of at least one external device 400 distributed in a specific indoor space where the control device 300 is used (e.g., device registration information of a smart home service) or indoor position information obtained by a known magnetic field map reading technique (e.g., a technique disclosed in Korean Registered Patent No. 10-1527212 of Idecca Inc.) may be employed.

Next, the database 230 according to one embodiment of the invention may store the motion data of the control device 300, the posture information derived according to the motion data, and/or rules for providing a control interface according to the posture change corresponding to the posture information. Although FIG. 2 shows that the database 230 is incorporated in the control assistance system 200, the database 230 may be configured separately from the control assistance system 200 as needed by those skilled in the art to implement the invention. Meanwhile, the database 230 according to the invention encompasses a computer-readable recording medium, and may refer not only to a database in a narrow sense but also to a database in a broad sense including file system-based data records and the like. The database 230 according to the invention may be even a collection of simple logs if one can search and retrieve data from the collection.

Next, the communication unit 240 according to one embodiment of the invention may function to enable data transmission/reception from/to the posture information derivation unit 210, the position information determination unit 220, and the database 230.

Lastly, the control unit 250 according to one embodiment of the invention may function to control data flow among the posture information derivation unit 210, the position information determination unit 220, the database 230, and the communication unit 240. That is, the control unit 250 according to the invention may control data flow into/out of the control assistance system 200 or data flow among the respective components of the control assistance system 200, such that the posture information derivation unit 210, the position information determination unit 220, the database 230, and the communication unit 240 may carry out their particular functions, respectively.

Configuration of the Control Device

Hereinafter, the internal configuration of the control device 300 according to the invention and the functions of the respective components thereof will be discussed.

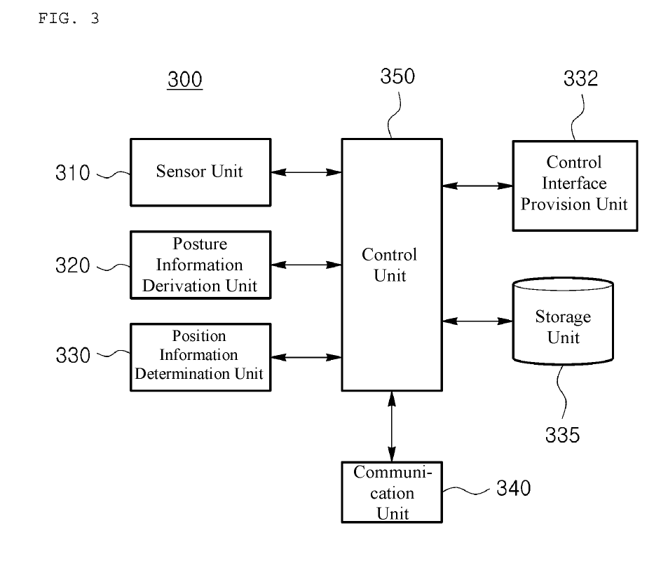

FIG. 3 specifically shows the internal configuration of the control device 300 according to one embodiment of the invention. As shown in FIG. 3, the control device 300 may comprise a sensor unit 310, a posture information derivation unit 320, a position information determination unit 330, a control interface provision unit 332, a storage unit 335, a communication unit 340, and a control unit 350. According to one embodiment of the invention, at least some of the sensor unit 310, the posture information derivation unit 320, the position information determination unit 330, the control interface provision unit 332, the storage unit 335, the communication unit 340, and the control unit 350 may be program modules to communicate with the control assistance system 200 or the external device 400. The program modules may be included in the control device 300 in the form of operating systems, application program modules, and other program modules, while they may be physically stored in a variety of commonly known storage devices. Further, the program modules may also be stored in a remote storage device that may communicate with the control device 300. Meanwhile, such program modules may include, but not limited to, routines, subroutines, programs, objects, components, data structures, and the like for performing specific tasks or executing specific abstract data types as will be described below in accordance with the invention.

First, the sensor unit 310 according to one embodiment of the invention may include sensors such as a motion sensor, an acceleration sensor, a gyroscope sensor, and a three-axis rotation sensor, which operate according to a motion of a user or a body part of the user. That is, the sensor unit 310 may comprise at least one of these known sensors. The sensor unit 310 may sense a motion of the control device 300 and output (or record) a data on the motion over time. The motion data may be physical values related to velocity, acceleration, three-axis rotation, and the like of the control device 300. The motion data may be stored in the storage unit 335 to be described below. Further, the sensor unit 310 may include a magnetic sensor for detecting terrestrial magnetism or the like.

Next, the posture information derivation unit 320 according to one embodiment of the invention may derive information on a motion trajectory of the control device 300 in which the sensor unit 310 is included, and information on a posture change that the user makes while wearing the control device 300 (which is estimated from the motion trajectory), on the basis of the output values over time of the sensor unit 310 (i.e., the motion data of the control device 300). The posture information may include information on the position where the control device 300 is worn on the user's body, as necessary. Here, the posture information derivation unit 320 is not essential, and all or some of its functions may be performed instead by the posture information derivation unit 210 that may be included in the control assistance system 200.

Next, the position information determination unit 330 according to one embodiment of the invention may determine information on a positional relationship between the control device 300 and the external device 400, according to the derived information on the posture change of the user. Here, the position information determination unit 330 is not essential, and all or some of its functions may be performed instead by the position information determination unit 220 that may be included in the control assistance system 200.

The principle of configuring the posture information derivation unit 320 or the position information determination unit 330 may be quite similar to that of configuring the posture information derivation unit 210 or the position information determination unit 220, and information or data used by them may also be identical or similar.

Next, the control interface provision unit 332 according to one embodiment of the invention may function to dynamically provide a control interface in the control device 300, on the basis of the determined positional relationship between the control device 300 and the external device 400. The control interface may include an interface that allows the user to select the external device 400 to be controlled, and an interface that allows the user to specifically control the selected external device 400. Particularly, the control interface may be a graphical interface that allows the user to intuitively recognize a position of the external device 400 with respect to the control device 300, as will be described below.

Particularly, the position of the external device 400 may be dynamically displayed with a graphical element in the control interface, and examples of the graphical element will be discussed below.

The above control interface may be (or may be included in) an application program that is activated when the user makes a specific posture change while wearing the control device 300 (i.e., the user's posture change may be a requirement for the activation) and displayed to the user. The application program may at least partially include the position information determination unit 330 or other components of the control device 300, as necessary. The application program may be downloaded from the control assistance system 200 or another server device to the control device 300.

Next, the storage unit 335 according to one embodiment of the invention may store the motion data of the control device 300, the posture information derived according to the motion data, and/or rules for providing a control interface according to the posture change corresponding to the posture information. The storage unit 335 may be a known storage device such as a hard disk drive and flash memory. Next, the communication unit 340 according to one embodiment of the invention may function to enable data transmission/reception from/to the sensor unit 310, the posture information derivation unit 320, the position information determination unit 330, the control interface provision unit 332, and the storage unit 335.

Lastly, the control unit 350 according to one embodiment of the invention may function to control data flow among the sensor unit 310, the posture information derivation unit 320, the position information determination unit 330, the control interface provision unit 332, the storage unit 335, and the communication unit 340. That is, the control unit 350 according to the invention may control data flow into/out of the control device 300 or data flow among the respective components of the control device 300, such that the sensor unit 310, the posture information derivation unit 320, the position information determination unit 330, the control interface provision unit 332, the storage unit 335, and the communication unit 340 may carry out their particular functions, respectively.

Derivation of the posture information Hereinafter, it will be discussed how the control assistance system 200 or the control device 300 derives information on a posture change of a user according to the invention.

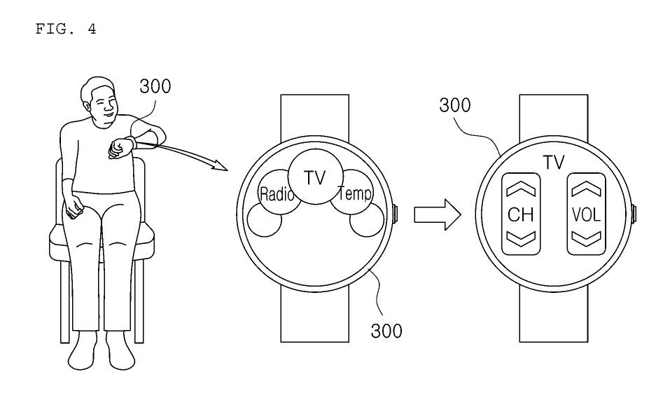

FIG. 4 shows a posture that a user may take for the control by a control device and a control interface at the time according to one embodiment of the invention.

As shown in the left part of FIG. 4, a user may take a posture to look at the control device 300 worn on his/her left wrist (typically, a smart watch). In this case, the posture of the user is inevitably changed. Since a motion trajectory or the like of a human arm is somewhat typical, the above action may cause a motion data of the sensor unit 310 of the control device 300 to be generated with a certain pattern (i.e., a motion trajectory characteristic) within a certain range. For example, such a pattern may be generated according to a trajectory that the left wrist typically makes as the user lifts it up from a position near the waist to a position in the field of view. Conversely, the motion data with a similar pattern may indicate, with a very high probability, that the user has moved the control device 300 worn on the left wrist as shown in the left part of FIG. 4.

In the above-described case, the motion data of the sensor unit 310 may be analyzed by the posture information derivation unit 320 for a predetermined period of time. The length of the period may be determined through some experiment by a person skilled in the art. The length of the period may be determined uniformly according to the judgment of a person skilled in the art, but may also be adaptively determined according to the type of the motion data or the motion trajectory characteristics represented by the motion data. The posture information derivation unit 320 may recognize predetermined posture information by comparing the characteristic pattern of a pre-stored motion data with that of a newly detected motion data. This may be related to a posture change made by the user or the body part where the control device 300 is worn.

Although it has been described above that the posture information derivation unit 320 of the control device 300 functions to derive the posture information, the posture information derivation unit 210 of the control assistance system 200 may perform at least a part of the function. In this case, the motion data of the sensor unit 310 may be transmitted to the control assistance system 200.

Accordingly, a control interface may be dynamically provided by the control interface provision unit 332, on the basis of information on a posture change recognized by the posture information derivation unit 210 or the posture information derivation unit 320.

The middle part of FIG. 4 shows an exemplary organization of the dynamically provided control interface. The principle of organizing the control interface will be discussed below.

The right part of FIG. 4 shows a control interface that is provided when a television is selected as the external device 400 to be controlled in the control interface shown in the middle part of FIG. 4.

Meanwhile, although the above example mainly refers to the user lifting up the wrist as the posture change of the user causing the control interface to be dynamically provided, the posture change may be actually captured in various ways. For example, such a posture change may also be captured on the basis of a motion data that typically appears when the user moves his/her left wrist and arm while lowering the head slightly to the left. A posture change may be captured even on the basis of a motion data related to a slight motion of the user twisting the upper body.

Dynamic Control Interface

Hereinafter, various embodiments in which control interfaces are dynamically provided will be described with reference to the accompanying drawings.

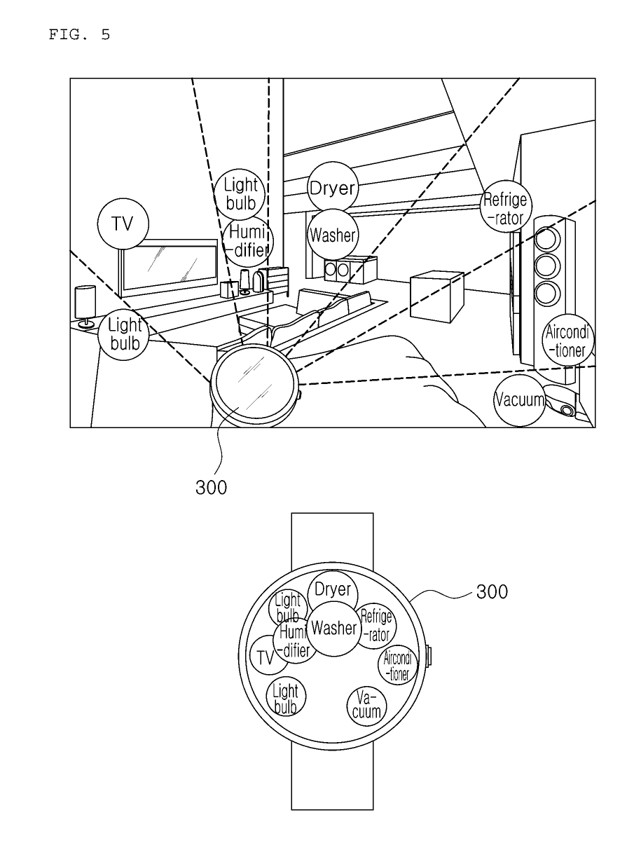

FIG. 5 shows an example of a control interface when a user wears a control device on his/her wrist indoors according to one embodiment of the invention. As shown in FIG. 5, the user may look at the control device 300 (e.g., a smart watch) while wearing the control device 300 on the wrist. In this case, the control device 300 may dynamically provide a control interface on the basis of a motion trajectory of the control device 300.

The control interface may be organized as shown in FIG. 5. That is, the control interface may be organized and provided according to positional relationships between the control device 300 and the various external devices 400 disposed in the indoor space where the control device 300 is located. Here, a graphical element corresponding to the external device 400 to be controlled by the control device 300 may be arranged and displayed according to the orientation or distance of the external device 400 with respect to the control device 300. The orientation may substantially coincide with the direction of the user's line of sight when the user wears and uses the control device 300. Further, the graphical elements of at least two external devices 400 lying in a similar orientation may be displayed relatively nearer to or farther from the user, depending on the difference in the distance as described above.

Accordingly, the user may recognize the external device 400 that may be controlled by the user very intuitively, and may select and touch an appropriate graphical element on the control interface. Such a touch may allow a dedicated control interface for the corresponding external device 400 to be provided as illustratively shown in the right part of FIG. 4. When it is advantageous to control at least two external devices 400 together, a plurality of corresponding graphical elements may be selected all together on the control interface, and then a predetermined menu for allowing the corresponding external devices 400 to be controlled together (e.g., including buttons that may be selected by the user) may be provided.

Although not shown, on the control interface, the graphical element of the external device 400, which has recently been controlled by the user, has received the user's attention for other reasons, or is currently in operation, may be specifically highlighted or preferentially displayed (e.g., on the first screen of the control interface). This feature may be particularly useful when the graphical elements of a large number of external devices 400 need to be displayed on the control interface. However, even when the external device 400 has recently been controlled or has received the user's attention, the highlighted or preferential display may not be performed if a predetermined time has elapsed since the recent control or the user's attention. Here, the user's attention may be any attention that may be recognized according to the context of the user's usage of the control device 300 or the external device 400. For example, the external device 400 related to an operation performed by the user in the control device 300, or in another device (not shown) recognizable to the control device 300, may be assumed to receive the user's attention.

Meanwhile, the above-described control interface may be provided with a lower priority than a notification message (e.g., of a messenger) that contextually needs to be preferentially displayed to the user on the screen of the control device 300, or may not be provided at all if the notification message has recently been provided within a predetermined time. This is because, for example, the user's action of lifting up the left wrist may be just intended to read the notification message. Of course, according to the choice of a person skilled in the art, the notification message and the control interface may be provided alongside in a state in which the screen of the control device 300 is visually divided.

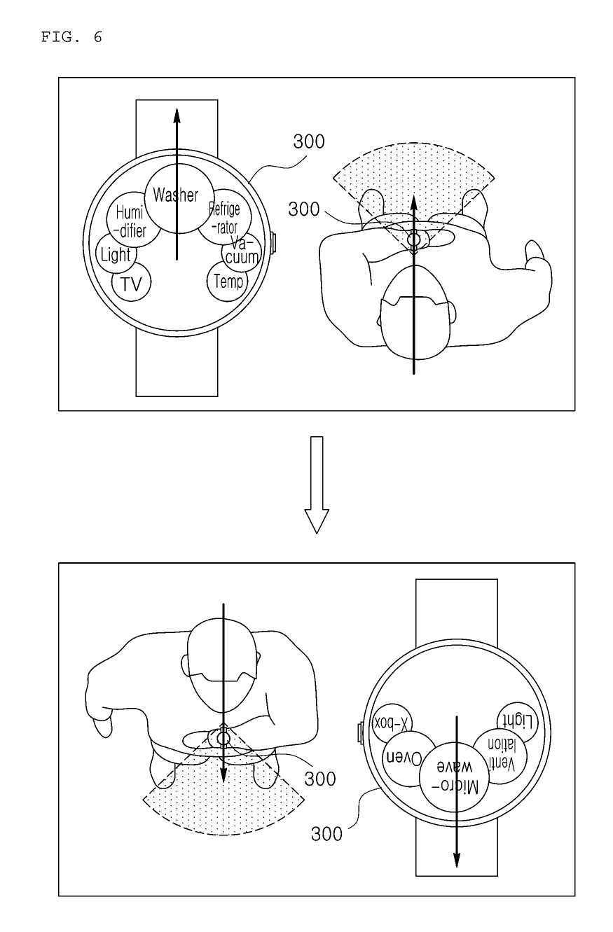

FIG. 6 shows an example of a control interface when a user uses a control device in a standing posture according to one embodiment of the invention.

As shown in the upper part of FIG. 6, the user may stand facing the front (i.e., the 12 o'clock position in FIG. 6), and the control device 300 may also be facing the front at this time. In this case, the control interface may display a plurality of external devices 400 disposed in the front, according to a positional relationship between the control device 300 and each of the external devices 400.

Then, the same user may turn around and face the rear (i.e., the 6 o'clock position in FIG. 6), and the control device 300 may also be facing the rear at this time. In this case, the control interface may display a plurality of other external devices 400 disposed in the rear, according to a positional relationship between the control device 300 and each of the external devices 400.

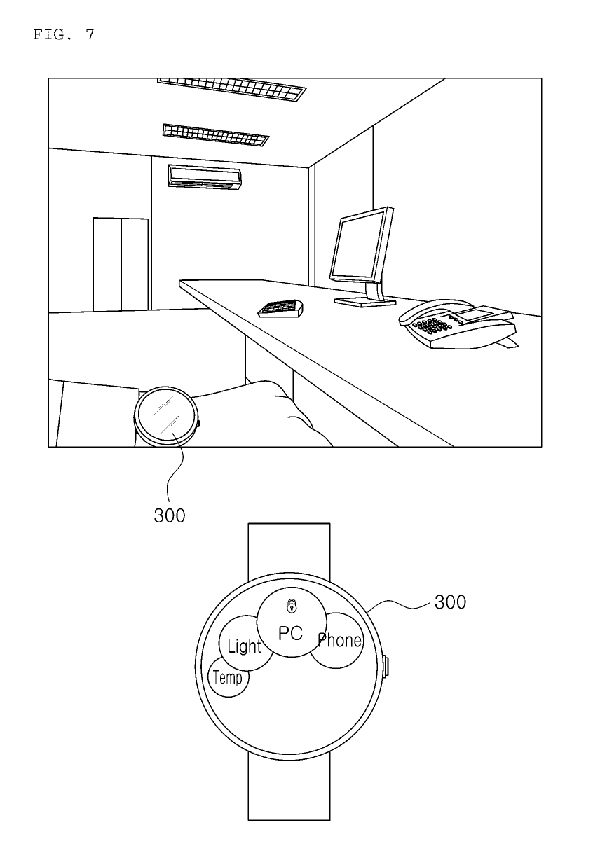

FIG. 7 shows an example of a control interface when a user uses a control device in a room according to one embodiment of the invention.

As shown in the upper part of FIG. 7, there may be a plurality of external devices 400 in the room. Here, as shown in the lower part of FIG. 7, the user may easily distinguish a personal computer (PC) only available to people having special authority, among the external devices 400, by the illustrated shape of the corresponding graphical element on the control interface. To this end, the control assistance system 200 may provide information that the personal computer requires authority for use to an application program including the control interface of the control device 300.

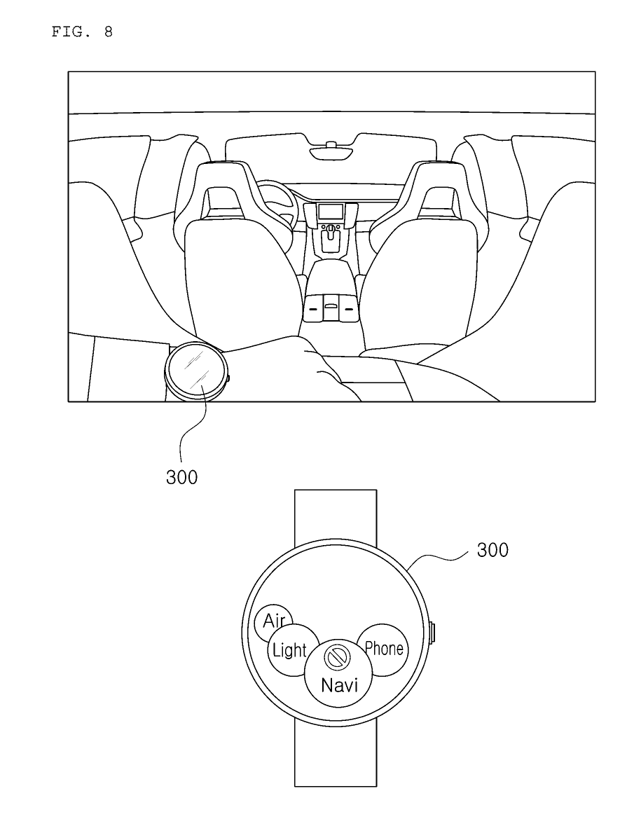

FIG. 8 shows an example of a control interface when a user uses a control device in an autonomous vehicle according to one embodiment of the invention.

As shown in the upper part of FIG. 8, there may be a plurality of external devices 400 in the autonomous vehicle. Here, as shown in the lower part of FIG. 8, the user may easily distinguish a navigator (i.e., a navigator having autonomous driving commands) only available to people over a specific age, among the external devices 400, on the control interface. The above user may be a minor of a lower age, and an application program including the control interface of the control device 300 may identify the age of the user and then disable a graphical element for controlling the navigator on the control interface at all.

Meanwhile, according to another embodiment of the invention, a control interface may be dynamically provided even on the basis of biometric information of a user wearing the control device 300. For example, when the control device 300 is a smart watch, it may not only collect information on a posture change of the user, but also collect a variety of biometric information such as a body temperature change and a pulse change. Accordingly, when there are a plurality of controllable external devices 400, the control interface may display an air conditioner in preference to others if the body temperature of the user who desires the control is high. This may assist the user to regulate the body temperature by quickly lowering the ambient temperature. Alternatively, when the control device 300 may recognize that the pulse rate of the user is higher than a normal rate, the control interface may preferentially display an indoor light, an electrically operated chair, an electrically operated bed, or the like to dim the indoor light and facilitate the use of the chair or bed so that the user may be more relaxed.

Although the above description has been given on the assumption that the user's input to the control device 300 (e.g., selecting a specific graphical element) is made by a physical touch, those skilled in the art will appreciate that the user's input may encompass various inputs such as making of a pre-arranged gesture, pointing, hovering, voice input, gaze input, and transmission of brain waves or similar signals. It will be apparent to those skilled in the art that the specific organization of the control interface according to the invention may be diversely changed in terms of visual or non-visual aspects, depending on the modality of the user input.

The embodiments according to the invention as described above may be implemented in the form of program instructions that can be executed by various computer components, and may be stored on a computer-readable recording medium. The computer-readable recording medium may include program instructions, data files, data structures and the like, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be changed to one or more software modules to perform the processes of the present invention, and vice versa.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for dynamically providing a control interface in a control device of a user, comprising the steps of:
deriving information on a posture change of the user, on the basis of a motion data of the control device, wherein the motion data is recorded over time by means of a sensor included in the control device; and
dynamically organizing and providing the control interface in the control device, on the basis of the derived information.

2. The method of claim 1, wherein the step of deriving the information on the posture change is performed on the basis of motion trajectory information collected and accumulated with respect to a plurality of other control devices.

3. The method of claim 1, wherein the step of deriving the information on the posture change is performed on the basis of a position where the control device is worn on the user.

4. The method of claim 1, wherein the step of organizing and providing the control interface is performed on the basis of a positional relationship between the control device and an external device to be controlled by the control device.

5. The method of claim 4, wherein there are a plurality of external devices to be controlled by the control device, and
wherein the control interface is provided including a plurality of graphical elements arranged according to a positional relationship between the control device and each of the plurality of external devices.

6. The method of claim 5, wherein the user is able to select each of the plurality of graphical elements, and
wherein a control interface for the corresponding external device is further provided to the user according to the selection by the user.

7. The method of claim 1, wherein the step of organizing and providing the control interface comprises the step of:
preferentially providing the user with a control means for an external device that has recently been controlled by the user, has received the user's attention, or is currently in operation.

8. The method of claim 1, wherein the step of organizing and providing the control interface comprises the step of:
preferentially providing the user with a control means for an external device that is determined to be necessary on the basis of measured biometric information of the user.

9. A computer-readable recording medium having stored thereon a computer program for executing the method of claim 1.

10. A control device for dynamically providing a control interface to a user, comprising:
a posture information derivation unit configured to derive information on a posture change of the user, on the basis of a motion data of the control device, wherein the motion data is recorded over time by means of a sensor included in the control device; and
a control interface provision unit configured to dynamically organize and provide the control interface in the control device, on the basis of the derived information.

11. The system of claim 10, wherein the posture information derivation unit is configured to derive the information on the posture change on the basis of motion trajectory information collected and accumulated with respect to a plurality of other control devices.

12. The system of claim 10, wherein the posture information derivation unit is configured to derive the information on the posture change on the basis of a position where the control device is worn on the user.

13. The system of claim 10, wherein the control interface provision unit is configured to organize the control interface on the basis of a positional relationship between the control device and an external device to be controlled by the control device.

14. The system of claim 13, wherein there are a plurality of external devices to be controlled by the control device, and
wherein the control interface is provided including a plurality of graphical elements arranged according to a positional relationship between the control device and each of the plurality of external devices.

15. The system of claim 14, wherein the user is able to select each of the plurality of graphical elements, and
wherein a control interface for the corresponding external device is further provided to the user according to the selection by the user.

16. The system of claim 10, wherein the control interface provision unit is configured to preferentially provide the user with a control means for an external device that has recently been controlled by the user, has received the user's attention, or is currently in operation.

17. The system of claim 10, wherein the control interface provision unit is configured to preferentially provide the user with a control means for an external device that is determined to be necessary on the basis of measured biometric information of the user.
